(19) United States
(12) Patent Application Publication
(10) Pub. No.: US 2004/0074098 A1
(43) Pub. Date: Apr. 22, 2004

(54) Cabinet scraper with handles

(76) Inventors: Christopher Schwarz, Fort Mitchell, KY (US); Matthew Bruce Siemers, Ottawa (CA)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/636,100

(22) Filed: Aug. 7, 2003

Related U.S. Application Data
(60) Provisional application No. 60/403,792, filed on Aug. 15, 2002.
(60) Provisional application No. 60/414,489, filed on Sep. 27, 2002.

(51) Int. Cl. B26B 1/00

(52) U.S. Cl. 30/169; 30/478

(57) ABSTRACT

A cabinet scraper that protects the scraper blade from damage due to contact with the body of the scraper and that protects the user from contact with the upper end of the blade, preferably by including a portion of the body that extends beyond the upper end of the blade. The blade is held in place by a clamp bar, and the shape of the blade may be modified using an adjustment screw. Preferably, the clamp bar includes a chamfer along an edge, so that shavings produced during scraping do not bunch up between the blade and body of the scraper.

### RELATED APPLICATION DATA

This application claims priority to U.S. Provisional Patent Application No. 60/403,792, filed Aug. 15, 2002 and to U.S. Provisional Patent Application No. 60/414,489, filed Sep. 27, 2002, each of which are incorporated herein by reference in their entirety.

### FIELD OF THE INVENTION

This invention relates to cabinet scrapers used in woodworking.

### BACKGROUND

Cabinet scrapers are used by woodworkers and cabinetmakers to create a smooth surface on work pieces. In general, existing handled cabinet scrapers, including the Stanley No. 80 scraper, consist of a body that holds a scraper blade at a specific angle. The blade is held in place with a clamp bar. The scraping action is adjusted by using an adjustment screw opposite the clamp bar to slightly bend or bow the blade, giving the blade a variable camber.

Existing cabinet scrapers, such as the Stanley No. 80, include a blade that extends above the body, leaving the top edge and comers of the blade exposed. This poses a safety hazard. The blade is typically relatively thin steel, the edges and comers of which are sharp. Furthermore, the upper and lower edges of the scraper blade may be sharpened, which extends the time between sharpening but increases the danger associated with the exposed blade. It is possible to modify the blade so that it is short enough that the edges do not extend above the body. However, doing so is not desirable, because the unused blade edge likely will be damaged by being pushed against the body casting due to the action of the clamp bar.

An additional problem associated with existing cabinet scrapers is that shavings produced by the blade tend to bunch up below the clamping bar and against the blade and the body of the scraper near the location where the shavings pass through the body.

### SUMMARY

This invention is a handled cabinet scraper that protects the scraper blade from damage due to contact with the body of the scraper and that protects the user from contact with the upper end of the blade, preferably by including a portion of the body that extends beyond the upper end of the blade. The blade is held in place by a clamp bar, and the position and shape of the blade may be modified using an adjustment screw. Preferably, the clamp bar includes a chamfer along a lower edge, so that shavings produced during scraping do not bunch up between the blade and body of the scraper.

### BRIEF DESCRIPTION OF THE DRAWINGS

FIG. 1 is a perspective view of the cabinet scraper of this invention.

FIG. 2 is a side elevation view in partial cross section of the cabinet scraper shown in FIG. 1.

FIG. 3 is an exploded perspective view of the cabinet scraper shown in FIG. 1.

FIG. 4 is an end elevation view of the back of the cabinet scraper shown in FIG. 1.

FIG. 5 is a top view of the cabinet scraper shown in FIG. 1.

FIG. 6 is an end elevation view of the front of the cabinet scraper shown in FIG. 1.

FIG. 7 is a side elevation view of the cabinet scraper shown in FIG. 1.

FIG. 8 is a perspective view of the clamp bar of the cabinet scraper shown in FIG. 1.

### DETAILED DESCRIPTION

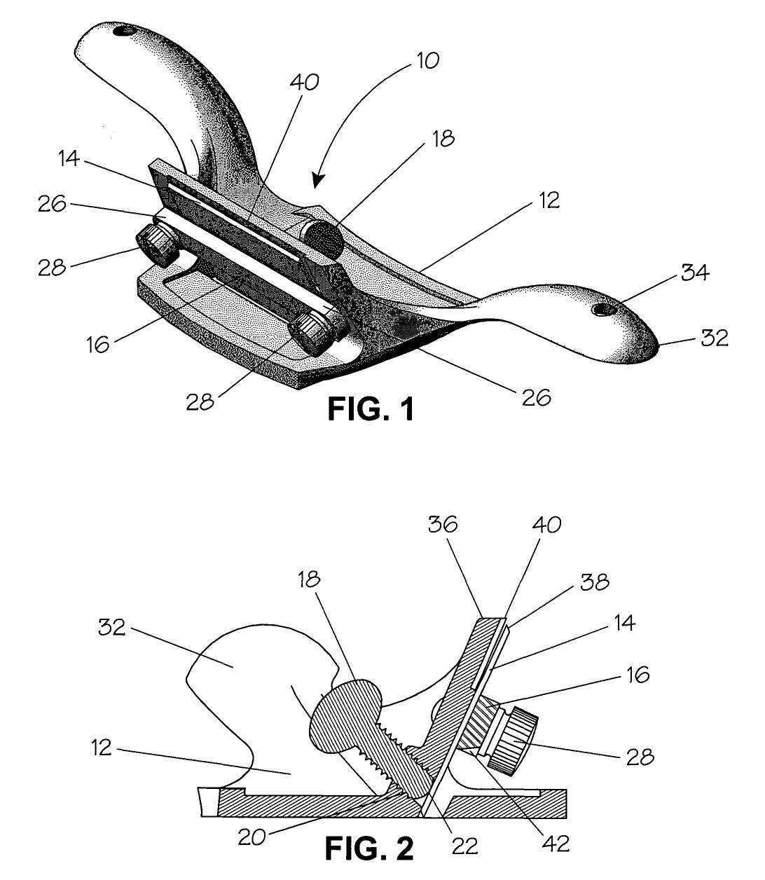

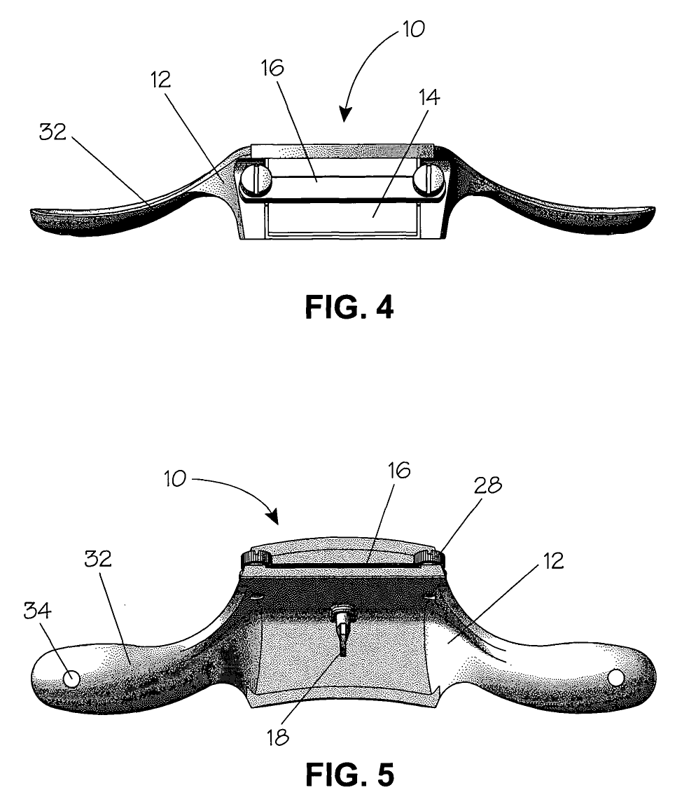

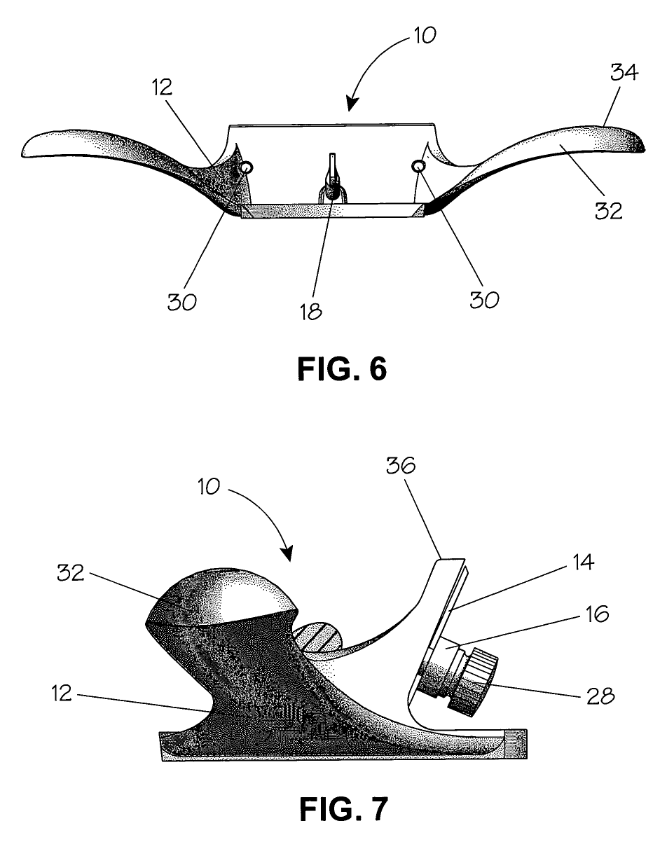

The cabinet scraper 10 of this invention, shown in FIGS. 1-7, includes body 12 that holds a scraper blade 14 at a specific angle. The blade 14 is held in place with a clamp bar 16. The scraping action is adjusted by using an adjustment screw 18 opposite the clamp bar 16 to slightly bend the blade. As shown in FIG. 2, adjustment screw 18 is received in adjustment screw aperture 20 in body 12. Tip 22 of screw 18 contacts an end of the blade 14, allowing adjustment of the blade 14.

As may be seen by reference to FIGS. 2, 3 and 8, the clamp bar 16 includes apertures 24 (not shown in FIG. 2) at ends 26 adapted to receive clamping screws 28. The body 12 has corresponding body apertures 30 adapted to receive clamping screws 28, which secure the clamp bar 16 to the body 12, holding the blade 14 in place between the body 12 and the clamp bar 16. The body 12 includes two handles 32 having handle apertures 34 for hanging the tool in storage.

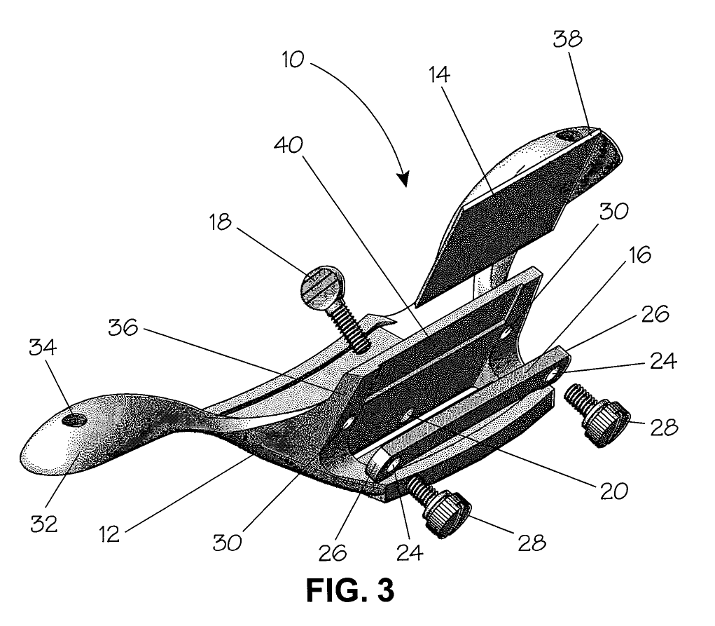

As may be seen by reference to FIGS. 2 and 3, the body casting 12 includes a body projection portion 36 that extends above and beyond the blade 14, thereby shielding the upper portion of blade 14 and protecting the user from harm that might result from contact with the blade 14. The projected portion 36 of the body 12 adjacent to the upper edge 38 of blade 14 is relieved in a recessed region 40, where the blade bed area is recessed to prevent the unused, sharp edge of the blade 14 from being damaged when the blade 14 is clamped into position. Such damage is avoided because there is no contact between the upper edge 38 of the blade 14 and any structure of the body 12.

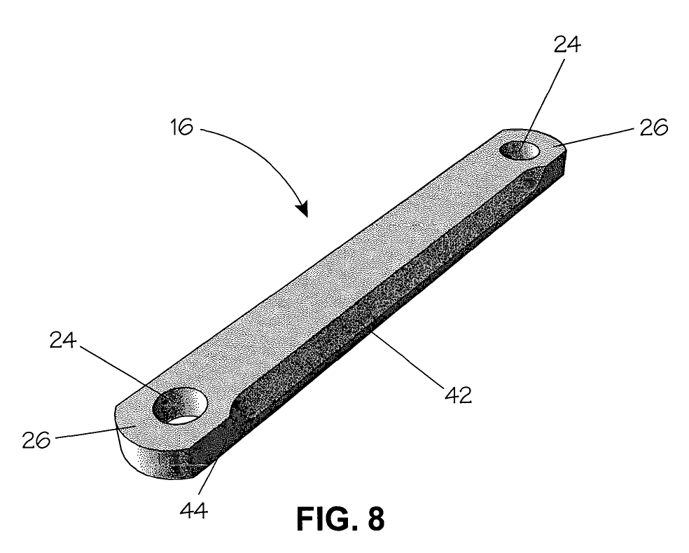

As may be seen by reference to FIGS. 2 and 8, the clamp bar 16 includes a bevel or chamfer 42 on the lower side 44 and between the ends 26 of the clamp bar 16. The chamfer 42 is formed by removing the lower comer of the clamp bar 16 away from the blade 14. This chamfer 42 permits shavings to exit the region of the blade 14 without accumulating under the clamp bar 16. While the chamfer 42 could be formed along the entire length of the clamp bar 16, it is preferable for the chamfer 42 to stop short of the entire length of the ends 26 of clamp bar 16 so that the heads of the clamping screws 28 can filly seat against the bar 16 when they are tightened. Thus, the stopped chamfer 42 does not allow shavings produced by the blade to bunch up below the clamp bar 16 and against the blade 14 and the body 12 of the scraper 10.

The body of the cabinet scraper may be fabricated from ductile iron, or any other suitable material. The clamp bar may be fabricated from mild (low carbon) steel, or any other suitable material.

All variations of the structures illustrated in the drawings and the materials described above are within the scope and spirit of this invention and the following claims.

1. A cabinet scraper, comprising a body having two integrally formed handles and a contact surface for contact with a blade having two ends, one of which contacts a workpiece during use of the cabinet scraper, the contact surface including a recessed portion, wherein at least a portion of the body extends beyond the end of the blade opposite the workpiece-contacting blade end.

2. The cabinet scraper of claim 1, further comprising a clamp bar having a second contact surface for contact with the blade.

3. The cabinet scraper of claim 2, further comprising means for securing the clamp bar to the body.

4. The cabinet scraper of claim 2, further comprising screws for securing the clamp bar to the body.

5. The cabinet scraper of claim 2, wherein the clamp bar further comprises a chamfer.

6. The cabinet scraper of claim 5, wherein the chamfer extends between apertures on each end of the clamp bar and does not extend the entire length of the clamp bar.

7. The cabinet scraper of claim 1, further comprising an adjustment screw for adjusting scraping action.

8. The cabinet scraper of claim 1, further comprising an adjustment screw for adjusting the camber of the blade.

9. A cabinet scraper comprising:
(a) a body;
(b) a blade: and
(c) a clamp bar for securing the blade to the body, the clamp bar comprising a chamfer.

10. The cabinet scraper of claim 9, further comprising means for securing the clamp bar to the body.

11. The cabinet scraper of claim 9, further comprising screws for securing the clamp bar to the body.

12. The cabinet scraper of claim 9, wherein the chamfer extends between apertures on each end of the clamp bar and does not extend the entire length of the clamp bar.

13. The cabinet scraper of claim 9, wherein the body further comprises a projection having a blade contact surface and a recessed portion that does not contact the blade and wherein at least a portion of the projection extends beyond the length of the blade.

14. A cabinet scraper, comprising:
(a) a blade having two ends, one of which contacts a workpiece during use of the cabinet scraper;
(b) a body comprising:
(1) two integrally formed handles, and
(2) a projection including a first contact surface for contact with the blade and a recessed portion that does not contact the blade, wherein at least a portion of the projection extends beyond the end of the blade opposite the workpiece-contacting blade end; and
(c) a clamp bar comprising a second contact surface for contact with the blade and a chamfer.
